(19) United States
(12) Patent Application Publication
(10) Pub. No.: US 2007/0052393 A1
(43) Pub. Date: Mar. 8, 2007

(54) Apparatus for preventing a malfunction

(75) Inventor: Shigeyuki Okayama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/319,728

(22) Filed: Dec. 29, 2005

(30) Foreign Application Priority Data
Sep. 8, 2005 (JP) 2005-261360

(51) Int. Cl. H02J 7/00

(52) U.S. Cl. 320/132

(57) ABSTRACT

A apparatus for preventing a malfunction prevents a malfunction during recovery from critical suspend. The apparatus includes: a voltage detection unit 2 detecting a voltage value from a secondary battery 1; a charging time monitor unit 4 outputting a system activation enable signal when a charging time of the secondary battery 1 by a AC adapter 3 is monitored and a predetermined time passes; and a power supply control unit 5 controlling a system power supply according to a voltage value detected by the voltage detection unit 2 and a system activation enable signal generated by the charging time monitor unit 4.

### BACKGROUND OF THE INVENTION

1. Field of the Invention

The present invention relates to an apparatus for preventing a malfunction of a mobileapparatus, etc. caused by an insufficient remaining amount of battery during recovery from critical suspend in electronic equipment provided with a secondary battery.

2. Description of the Related Art

When a remaining amount of battery is detected and the remaining amount is not sufficient or the charge for the secondary battery is not sufficient in equipment provided with a secondary battery, the function of suppressing the activation of the equipment is required.

As a system of detecting the remaining amount of battery to realize the above-mentioned function, there has been the system of detecting a remaining amount of battery by accumulating a current in a microcomputer for electric power supply, etc., but a necessary circuit is very large and costly.

Therefore, in a mobile terminal and electronic equipment such as a notebook PC, a PDA, a mobile telephone, etc., a system of calculating the remaining amount of battery of a secondary battery only based on the voltage of a battery without calculating current accumulation is frequently used.

FIG. 1 shows a configuration example of a apparatus for preventing a malfunction for calculating a remaining amount of battery from the battery voltage of a secondary battery. The device shown in FIG. 1 includes: an ADC (A/D converter) 6 for converting a voltage value from a secondary battery 1 to a digital value, an AC adapter detection circuit 8 for detecting that charging by an AC adapter 3 has been started; and a power supply control unit 60 for controlling the power supply of the system.

The power supply control unit 60 is provided with a table indicating the characteristic of the secondary battery 1, for example, a table (hereinafter referred to as a “characteristic table”) indicating the relationship between the voltage value and the remaining amount of battery of the secondary battery 1. When the ADC 6 notifies the power supply control unit 60 of the voltage value of the secondary battery 1, the unit acquires the remaining amount of battery by referring to the characteristic table, and controls the system such that the power supply can be suppressed when the remaining amount of battery is less than a predetermined amount.

However, in the system of calculating the remaining amount of battery only from the battery voltage of the secondary battery 1 shown in FIG. 1, it is hard to correctly calculate the remaining amount of battery because of the variance, etc. of the battery characteristic generated by the individual difference of the secondary battery 1 during manufacture. Therefore, there has been the problem that it is difficult to correctly determine whether or not the charge to the secondary battery 1 is sufficient.

Therefore, although it is determined that the AC adapter is connected and the secondary battery 1 is sufficiently charged to recover from the critical suspend, there is the possibility that the charge to the secondary battery 1 is actually insufficient. In this case, the system operating using a secondary battery as a power source cannot obtain operable voltage, thereby possibly causing a malfunction.

The critical suspend refers to the function of setting equipment in an operation stop status by storing the contents of data being used forcibly in the memory, turning off unnecessary devices and reducing power consumption to prevent data destruction, etc. by suddenly stopping electronic equipment such as a notebook PC, etc. by an insufficient remaining amount of secondary battery.

Japanese Published Patent Application No. SHO 61-191235 discloses a load characteristic detection apparatus capable of correctly and continuously detecting the voltage characteristic of a load. Japanese Published Patent Application No. HEI 06-035576 discloses a battery drive electric equipment apparatus for realizing the function of performing correct resumption with a simple configuration.

### SUMMARY OF THE INVENTION

The present invention has been developed to solve the above-mentioned problem, and aims at providing a apparatus for preventing a malfunction during recovery from critical suspend. A simple power supply monitor apparatus for calculating a remaining amount of battery from the voltage of a secondary battery can provide the technique of preventing a malfunction.

To attain the above-mentioned objective, the apparatus for preventing a malfunction according to the present invention includes: a charging time monitor unit for measuring the charging time of the secondary battery in the operation stop state of the electronic equipment by the detection of a low voltage of the secondary battery; and a power supply control unit for supplying power to the system in the case where a charge measuring time exceeds predetermined time with a predetermined remaining amount of secondary battery or more.

According to the present invention, the power supply control unit supply power to the system in the case where the remaining amount of battery exceeds a predetermined remaining amount of battery, and the charge measuring time exceeds a predetermined time.

Therefore, although it is mistakenly determined that there is an amount equal to or more than a predetermined remaining amount of battery (that is, there is a remaining amount of battery enough to activate a system) because there is an error in the remaining amount of battery calculated from the voltage value detected by the voltage detection unit due to the variance, etc. of the battery characteristic caused by the individual difference during manufacture of the secondary battery, no power is supplied to the system until a predetermined time passes.

That is, the present invention can have the effect of preventing a malfunction due to a voltage drop during recovery from critical suspend.

The apparatus for preventing a malfunction according to the present invention is configured by a voltage detection unit for detecting a voltage value of a secondary battery, and a characteristic table indicating the relationship between the voltage value of the secondary battery and a remaining amount of battery, and the power supply control unit is configured to obtain a remaining amount of battery at the voltage detected by the voltage detection unit by referring to the characteristic table.

As a result, with a simple power supply monitor apparatus for calculating the remaining amount of battery from the voltage of a secondary battery, the present invention has the effect of preventing a malfunction due to a voltage drop during recovery from critical suspend.

As described above, the present invention can provide a apparatus for preventing a malfunction during recovery from critical suspend with a simple power supply monitor apparatus for calculating the remaining amount of battery only from the voltage of the secondary battery.

### BRIEF DESCRIPTION OF THE DRAWINGS

FIG. 1 shows a configuration example of a device for calculating a remaining amount of battery only from the battery voltage of a secondary battery;

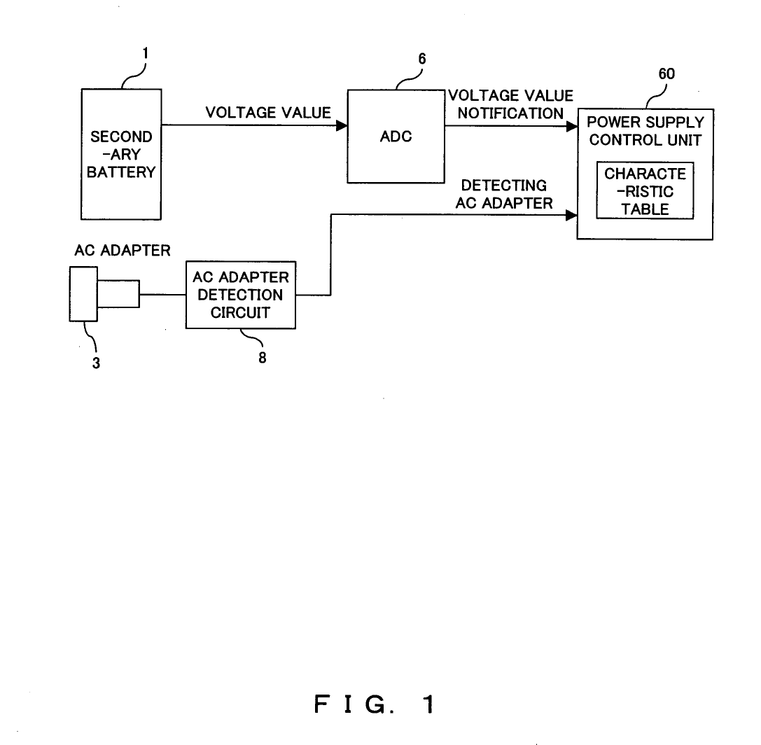

FIG. 2 shows the principle of the apparatus for preventing a malfunction according to the present invention;

FIG. 3 shows a configuration example of the apparatus for preventing a malfunction according to the present invention;

FIG. 4 shows a practical configuration example of the AC adapter charging time monitor circuit according to the present invention;

FIG. 5 is a flowchart of the process of the apparatus for preventing a malfunction according to an embodiment of the present invention; and

FIG. 6 shows a variation example of the apparatus for preventing a malfunction shown in FIG. 3.

### DESCRIPTION OF THE PREFERRED EMBODIMENTS

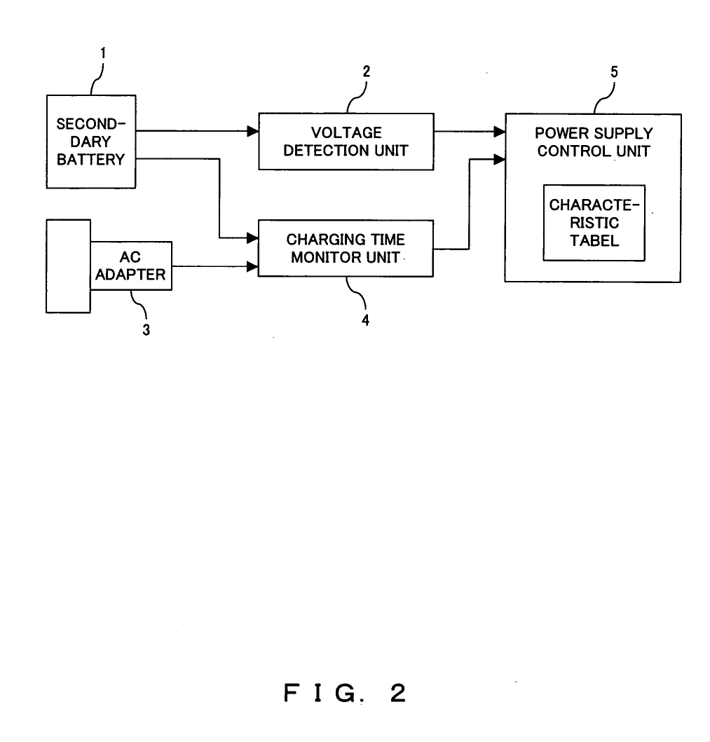

An embodiment of the present invention is explained below by referring to FIGS. 2 through 6.

FIG. 2 shows the principle of the apparatus for preventing a malfunction according to the present invention.

The apparatus for preventing a malfunction shown in FIG. 2 includes: a voltage detection unit 2 for detecting a voltage value from the secondary battery 1; a charging time monitor unit 4 for monitoring the time in which the secondary battery 1 is charged by the AC adapter 3 and outputting a system activation enable signal when a predetermined time passes; and a power supply control unit 5 for controlling the system power supply based the voltage value detected by the voltage detection unit 2 and the system activation enable signal generated by the charging time monitor unit 4.

The charging time monitor unit 4 determines from the voltage value of the secondary battery 1 whether or not there is critical suspend, and detects the charge of the secondary battery 1 by the AC adapter 3. Then, the charging time of the secondary battery by the AC adapter in the critical suspend is measured, and the system activation enable signal is output to the power supply control unit 5 when the measuring time exceeds the predetermined time.

The power supply control unit 5 includes a characteristic table. When the voltage detection unit 2 notifies the power supply control unit 5 of the voltage value, the power supply control unit 5 refers to the characteristic table and obtains a remaining amount of battery (hereinafter referred to as a “detected remaining amount of battery”), and determines whether or not the detected remaining amount of battery is equal to or more than a reference value. Only when the detected remaining amount of battery is equal to or more than the reference value and the system activation enable signal is detected from the charging time monitor unit 4, the system is turned on.

System power supply refers to the power supply of equipment driven by a secondary battery, and refers to the main power supply of the equipment provided with the apparatus for preventing a malfunction of the present invention. Especially, it refers to the main power supply of a mobile terminal and electronic equipment such as a notebook PC, a PDA, a mobile telephone, etc.

A system refers to equipment driven by a secondary battery. Specifically, it refers to a mobile telephone, electronic equipment, etc. such as a notebook PC, a PDA, a mobile telephone, etc.

With the above-mentioned configuration, the power supply control unit 5 prevents the system from being powered up until the system activation enable signal generated by the charging time monitor unit 4 is detected although the detected remaining amount of battery obtained from the voltage value detected by the voltage detection unit 2 is equal to or more than a reference value, that is, although it is determined that there is a sufficient remaining amount of battery in the secondary battery.

Therefore, since the system can be powered up only when there is a sufficient remaining amount of battery without depending on the variance, etc. of the battery characteristic of the secondary battery 1, the malfunction of electronic equipment caused by an insufficient remaining amount of battery during recovery from critical suspend can be avoided.

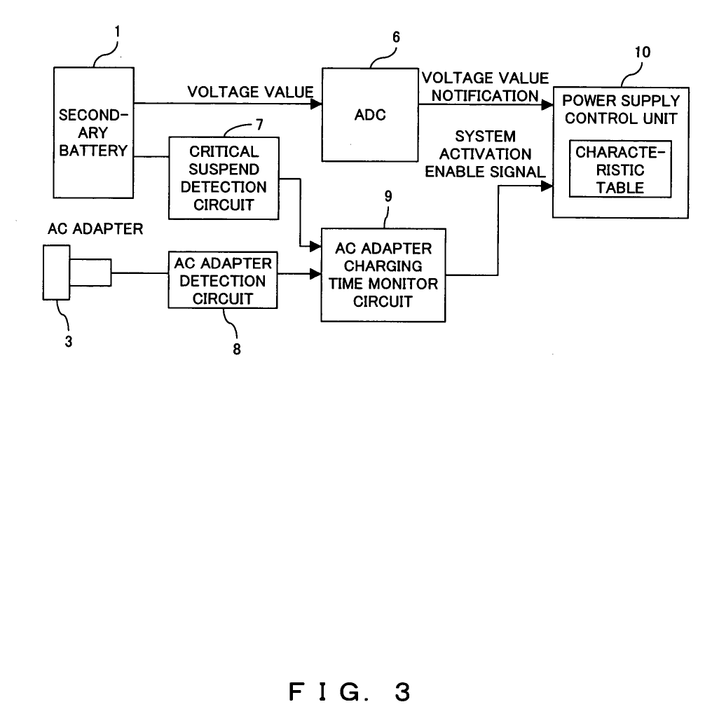

Described below is a practical example of the apparatus for preventing a malfunction according to the present invention. In the present embodiment shown in FIG. 3, the voltage detection unit 2 is realized by the ADC 6. The charging time monitor unit 4 is realized by a critical suspend detection circuit 7, the AC adapter detection circuit 8, and an AC adapter charging time monitor circuit 9. The power supply control unit 5 is realized by a power supply control unit 10.

FIG. 3 shows a configuration example of the apparatus for preventing a malfunction according to the present invention.

The apparatus for preventing a malfunction shown in FIG. 3 includes: the ADC 6 for digitizing the output voltage of the secondary battery (for example, a lithium-ion battery) 1; a critical suspend detection circuit 7 for detecting critical suspend from the voltage value of the secondary battery 1; the AC adapter detection circuit 8 for detecting the charge of the secondary battery 1 by the AC adapter 3; the AC adapter charging time monitor circuit 9 for monitoring the charging time of the secondary battery 1 by the AC adapter 3; and the power supply control unit 10 for controlling the power supply according to the voltage value notified by the ADC 6 and the system activation enable signal from the AC adapter charging time monitor circuit 9.

The secondary battery 1 is connected to the AC adapter 3 through a predetermined circuit (for example, a regulator, etc.) for charge, but it is the device configuration for common charge to the secondary battery 1 by the AC adapter 3. Therefore, the detailed explanation is omitted here.

The ADC 6 is a normal A/D conversion circuit for digitizing the output voltage of the secondary battery 1. The digitized output voltage value of the secondary battery 1 is notified to the power supply control unit 10.

The critical suspend detection circuit 7 is configured by a comparator for receiving an output voltage of the secondary battery 1 and a predetermined reference voltage (hereinafter referred to as a “critical suspend detection reference voltage”). When the output voltage of the secondary battery 1 is lower than the critical suspend detection reference voltage, it is notified to the AC adapter charging time monitor circuit 9.

Since the critical suspend is to be performed when the output voltage of a secondary battery is lower than the minimum operable voltage of the system, the critical suspend detection reference voltage is to be set to the minimum operable voltage.

The AC adapter detection circuit 8 is configured by a comparator for receiving an output voltage of the AC adapter 3 and a predetermined reference voltage (hereinafter referred to as an “AC adapter detection reference voltage”). When the output voltage of the AC adapter 3 is higher than the AC adapter detection reference voltage, an AC adapter detection signal (charge detection signal) is generated, and notified to the AC adapter charging time monitor circuit 9.

For example, it is common that when the rated voltage of the secondary battery 1 is 4.2 [V], the AC adapter 3 applies the voltage of 5.0 [V] to the secondary battery 1 for charge. In this case, when the AC adapter detection reference voltage is set to 5.0 [V] in advance, and the output voltage of the AC adapter 3 is equal to or higher than the AC adapter detection reference voltage, an AC adapter detection signal is to be generated.

When the AC adapter detection circuit 8 inputs an AC adapter detection signal to the AC adapter charging time monitor circuit 9, a predetermined time count starts. When a critical suspend detection signal is output from the critical suspend detection circuit 7, a system activation enable signal is output to the power supply control unit 10. A predetermined time counted by the AC adapter charging time monitor circuit 9 can be the time obtained by statistically measuring the time the secondary battery 1 is charged by the AC adapter 3.

The power supply control unit 10 is provided with a characteristic table indicating the characteristic of a secondary battery. When the ADC 6 notifies the power supply control unit 10 of the voltage value of the secondary battery, the power supply control unit 10 acquires the remaining amount of battery by referring to the characteristic table. It compares the remaining amount of battery with the remaining amount of battery with which the system can be stably operated (hereinafter referred to as a “remaining amount of battery for operation”). When the remaining amount of battery is equal to or more than the remaining amount of battery for operation and the AC adapter charging time monitor circuit 9 issues a system activation enable signal, it is determined that the secondary battery 1 is sufficiently charged, and the system is turned on.

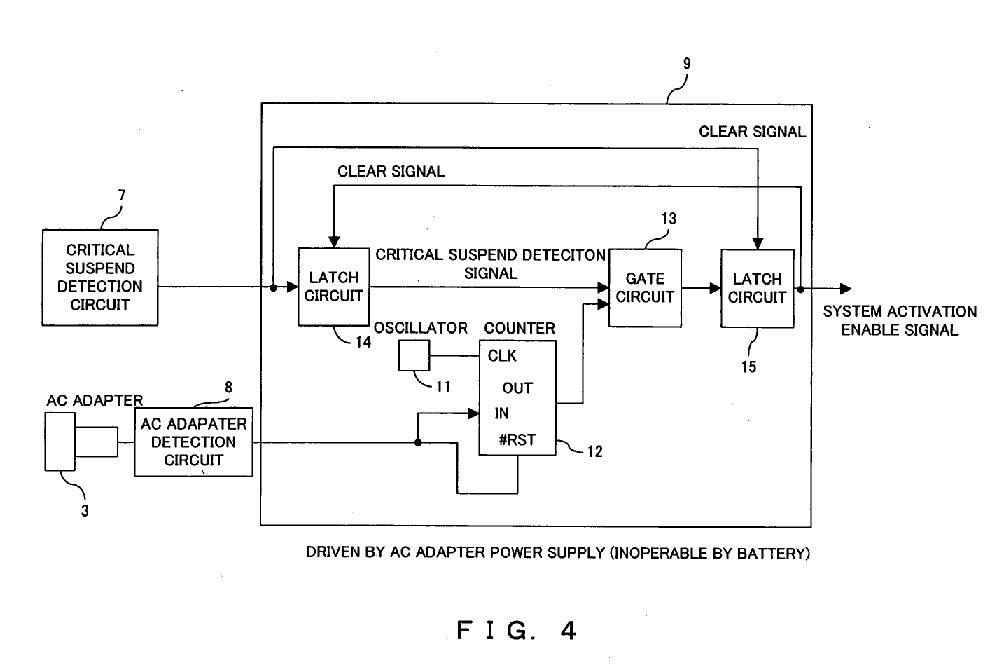

FIG. 4 shows a practical configuration example of the AC adapter charging time monitor circuit 9 according to the present invention.

The AC adapter charging time monitor circuit 9 shown in FIG. 4 includes: an oscillator 11 for generating a clock signal; a counter circuit 12 for counting a clock signal from the oscillator 11; a gate circuit 13 for obtaining a logical sum of a signal from the counter circuit 12 and a signal from a latch circuit 14; a latch circuit 14 for latching a critical suspend detection signal from the critical suspend detection circuit 7; and a latch circuit 15 for latching a system activation enable signal from the gate circuit 13.

The oscillator 11 is a common oscillation circuit for generating a clock signal having a predetermined frequency.

The counter circuit 12 receives a clock signal from the oscillator 11 and an AC adapter detection signal from the AC adapter detection circuit 8, and performs counting according to the clock signal from the oscillator 11 while the AC adapter detection signal indicating the detection of the AC adapter is input.

When the count value reaches a predetermined value, the counter circuit 12 outputs a high level signal to the gate circuit 13.

When the counter circuit 12 detects the charge of the secondary battery 1 by the AC adapter 3 according to the AC adapter detection signal from the AC adapter detection circuit 8, it continues counting up to a predetermined count value according to the clock signal generated by the oscillator 11, and outputs a high level signal to the gate circuit 13 when the predetermined count value is reached.

The gate circuit 13 is a logical circuit for obtaining a logical sum between the output signal from the counter circuit 12 and the output signal from the latch circuit 14. Therefore, when the signal from the latch circuit 14, that is, the critical suspend detection signal from the critical suspend detection circuit 7, and the output signal from the counter circuit 12 are high level signals, the high level signals (system activation enable signals) are output to the latch circuit 15.

The latch circuit 14 is configured by a D flip-flop, latches the critical suspend detection signal from the critical suspend detection circuit 7, and outputs it to the gate circuit 13. The latch circuit 14 uses the output signal of the latch circuit 15 as a reset signal.

Therefore, when a system activation enable signal is output from the latch circuit 15, the critical suspend detection signal output from the latch circuit 14 is reset.

The latch circuit 15 is configured by a D flip-flop, latches the output signal of the gate circuit 13, and outputs it to the power supply control unit 10. The latch circuit 15 uses the critical suspend detection signal from the critical suspend detection circuit 7 as a reset signal.

Therefore, when the critical suspend detection circuit 7 detects critical suspend, the system activation enable signal output from the latch circuit 15 is reset.

For example, when the system enters critical suspend, the critical suspend detection circuit 7 outputs a critical suspend detection signal (high level signal) to the latch circuit 14.

On the other hand, since the critical suspend detection signal from the critical suspend detection circuit 7 is input as a clear signal to the latch circuit 15, the data latched by the latch circuit 15 is cleared. That is, the system activation enable signal is cleared, and the power supply control unit 10 controls the system not to be activated.

When a user starts charging a secondary battery by the AC adapter 3, the AC adapter detection circuit 8 detects charging a secondary battery by the AC adapter 3, and outputs a high level signal as an AC adapter detection signal to the counter circuit 12.

The counter circuit 12 is reset by the AC adapter detection signal, and start counting a clock signal from the oscillator 11. When a predetermined count value is reached, the counter circuit 12 outputs a high level signal to the gate circuit 13.

At this time, since the output signal from the counter circuit 12 and the output signal from the latch circuit 15 are high level signals, the output signal from the gate circuit 13 is also a high level signal. That is, the system activation enable signal is output from the gate circuit 13 to the latch circuit 15.

Then, the latch circuit 15 outputs a system activation enable signal to the power supply control unit 10.

Since the output signal of the latch circuit 15 is input as a clear signal to the latch circuit 14, the data latched by the latch circuit 14 is cleared.

Although the AC adapter charging time monitor circuit 9 shown in FIG. 4 is configured to include the latch circuits 14 and 15, the present invention is not limited to this configuration, and the circuits can be outside the AC adapter charging time monitor circuit 9.

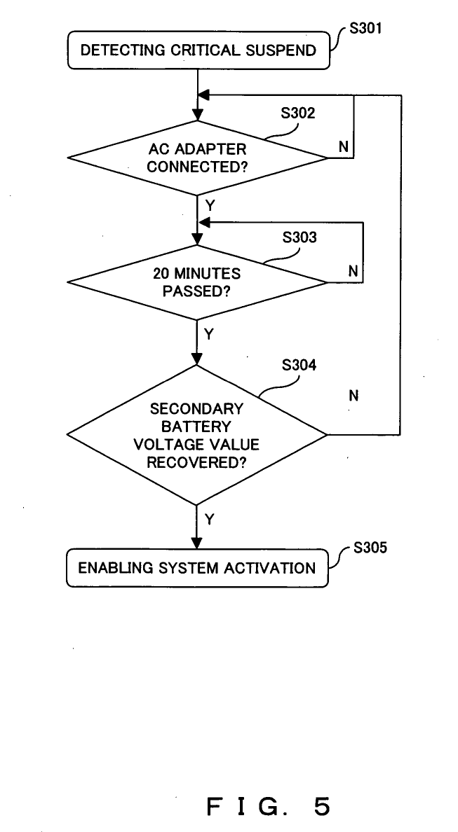

FIG. 5 is a flowchart of the process of the apparatus for preventing a malfunction according to the present embodiment.

In step S301, when the system enters critical suspend, the critical suspend detection circuit 7 detects the critical suspend, and outputs a critical suspend detection signal to the AC adapter charging time monitor circuit 9.

To recover the system from the critical suspend, for example, a user, etc. starts charging the secondary battery 1 by the AC adapter 3.

At this time, in step S302, the AC adapter detection circuit 8 detects the charge of the secondary battery 1 by the AC adapter 3 from the comparison result between the output voltage of the AC adapter 3 and a predetermined reference voltage. When the charge of the secondary battery 1 by the AC adapter 3 is not detected, the process in step S302 is repeated.

For example, in the case of a secondary battery having the rated voltage of 4.2 [V], the predetermined reference voltage of 5.0 [V] is compared with the output voltage of the AC adapter 3. If the output voltage of the AC adapter 3 is equal to or higher than the reference voltage, the adapter detection signal (high level signal) is output to the latch circuit 14 of the AC adapter charging time monitor circuit 9.

In step S303, when the charge of the secondary battery 1 by the AC adapter 3 is detected, the AC adapter charging time monitor circuit 9 counts a predetermined time (20 minutes in the present embodiment). When the predetermined time passes, the AC adapter charging time monitor circuit 9 outputs a system activation enable signal to the power supply control unit 10.

In step S304, when a system activation enable signal is input from the AC adapter charging time monitor circuit 9, the power supply control unit 10 refers to a characteristic table, and acquires the remaining amount of battery of the secondary battery corresponding to the voltage value of the secondary battery 1 input from the ADC 6.

When the acquired remaining amount of battery is equal to or larger than a predetermined value (for example, 30% of the battery capacity), it is determined that the secondary battery voltage value has been recovered.

When the acquired remaining amount of battery is smaller than the predetermined value (for example, 30% of the battery capacity), it is determined that the secondary battery voltage value has not been recovered, control is passed to step S302, and the processes in steps S302 through S304 are repeated.

When a user, etc. turns on the system using a power supply switch, etc., the power supply control unit 10 powers up in step S304 and activates the system (step S305).

As explained above, when the secondary battery is not sufficiently charged, the power supply control unit 10 does not power supply the system. Thus, although the charge by the AC adapter is stopped, and the system is to be activated, the system immediately enters critical suspend. Therefore, the malfunction of a system, which is provided with power from an insufficiently charged secondary battery after critical suspend, enters a low voltage state, and performs incomplete operations, can be prevented.

Furthermore, since the AC adapter charging time monitor circuit 9 is operated by electric power provided from the AC adapter 3, the malfunction due to incomplete operations of a system in a low voltage state can be avoided without influence on a current consumption of a secondary battery.

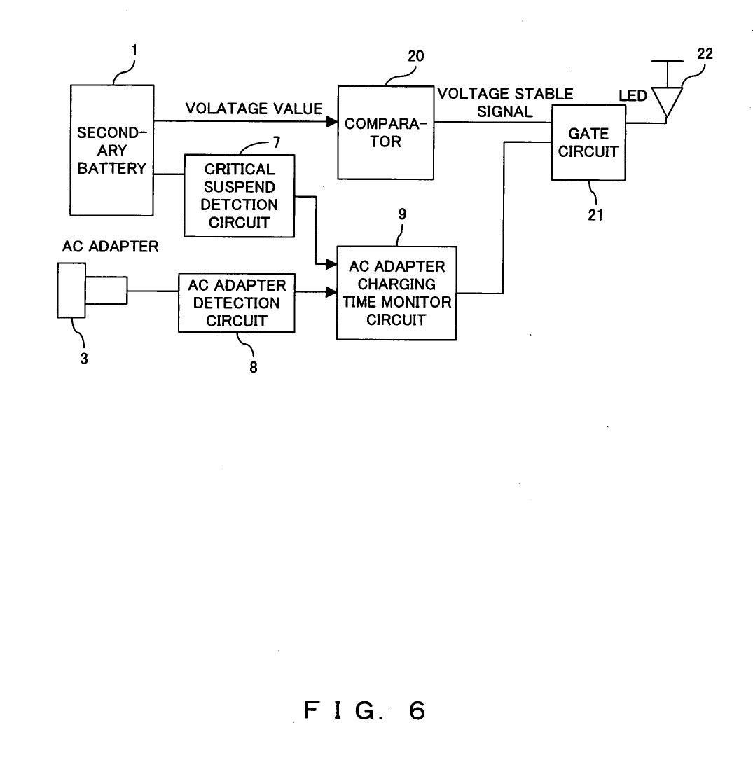

FIG. 6 shows a variation example of the apparatus for preventing a malfunction shown in FIG. 3. A stable voltage detection unit according to the present embodiment is realized by a comparator 20 shown below. The notification unit according to the present invention is realized by a gate circuit 21 and an LED 22.

The apparatus for preventing a malfunction shown in FIG. 6 includes: the comparator 20 for comparing the output voltage of the secondary battery 1 with a reference voltage and determining whether or not the voltage is stable; the critical suspend detection circuit 7 for detecting critical suspend from the voltage value of the secondary battery 1; the AC adapter detection circuit 8 for detecting the charge of the secondary battery 1 by the AC adapter 3; the AC adapter charging time monitor circuit 9 for monitoring the charging time of the secondary battery 1 by the AC adapter 3; the gate circuit 21 for obtaining a logical sum of the signal from the AC adapter charging time monitor circuit 9 and the signal from the comparator 20; and the LED 22 turned on according to the signal from the gate circuit 21.

The comparator 20 compares the output voltage of the secondary battery 1 with a predetermined reference voltage (hereinafter referred to as a “stable reference voltage”), and outputs a voltage stable signal to the gate circuit 21 when the secondary battery 1 indicates a voltage equal to or higher than the stable reference voltage.

The stable reference voltage can be statistically determined from the voltage measurement result and the battery characteristic of a secondary battery. For example, a voltage corresponding to 50% of the battery capacity can be used as a stable reference voltage according to the characteristic table.

The gate circuit 21 is a logical circuit for obtaining a logical sum of the output signal from the AC adapter charging time monitor circuit 9 and the voltage stable signal from the comparator 20. Therefore, the output of the gate circuit 21 becomes a high level signal when both the system activation enable signal from the AC adapter charging time monitor circuit 9 and the voltage stable signal from the comparator 20 become high level signals, thereby turning off the LED 22 which is currently lighted red.

That is, only when the secondary battery exceeds the stable reference voltage, and the AC adapter 3 performs charging for a predetermined time, the LED 22 is turned off, thereby allowing a user to realize that the AC adapter 3 can be removed.

When one of or both of the system activation enable signal from the AC adapter charging time monitor circuit 9 and the output signal from the comparator 20 is other than a high level signal, the output signal of the gate circuit 21 is a low level signal. Therefore, the LED 22 continues lighting, and notifies a user that the AC adapter 3 cannot be removed.

Therefore, in the present embodiment, only with a sufficient remaining amount of battery, a system can be turned on. As a result, a malfunction of electronic equipment caused by an insufficient remaining amount of battery during recovery from critical suspend can be avoided with a simpler configuration.

In FIG. 6, the LED 22 is used as a notification unit to a user, but a status LCD (liquid crystal display) indicating a state as to whether or not a system can be powered up, and a audio source circuit can also be used.

1. An apparatus for preventing a malfunction, comprising:
a charging time monitor unit measuring a charging time of a battery in an operation stop status of an electronic equipment due to a low voltage detection on the battery; and
a power supply control unit supplying power to a system in the case where a remaining amount of battery of the battery is equal to or more than a predetermined remaining amount of battery, and in the case where a charge measuring time exceeds a predetermined time.

2. The apparatus according to claim 1, wherein the charging time monitor unit outputs a system activation enable signal in the case where the charge measuring time of the battery exceeds a predetermined time, and the power supply control unit supplies power to a system in the case where a remaining amount of battery of the battery is equal to or more than a predetermined remaining amount of battery and in the case where the system activation enable signal is detected.

3. The apparatus according to claim 1, further comprising: a voltage detection unit detecting a voltage value of the battery; and a characteristic table indicating a relationship between a voltage value of the battery and a remaining amount of battery, wherein the power supply control unit refers to the characteristic table, and acquires a remaining amount of battery at a voltage detected by the voltage detection unit.

4. The apparatus according to claim 1, wherein
the charging time monitor unit comprises: a detection unit continuing outputting a detection signal until the electronic equipment is recovered after the operation stop status is detected from a voltage value of the battery; a charge detection unit outputting a charge detection signal in the case of detecting charge of a battery by an AC adapter; and an AC adapter charging time monitor unit outputting a system activation enable signal if the operation stop status is detected in the case where counting is performed up to a predetermined time while the charge detection signal is input.

5. The apparatus according to claim 4, further comprising:
a stable voltage detection unit receiving a voltage of the battery and a predetermined reference voltage, and generating a voltage stable signal in the case where the voltage of the battery is equal to or higher than the predetermined reference voltage; and a notification unit notifying that a system can be activated in the case of simultaneously detecting a voltage stable signal generated by the stable voltage detection unit and a system activation enable signal generated by the AC adapter charging time monitor unit, and notifying that the system cannot be activated in the case where at least one of the signals is not detected.

6. The apparatus according to claim 4, wherein
the AC adapter charging time monitor unit is a counter circuit starting counting in the case where the charge detection signal is input, and comprises: a counter circuit generating a count completion notification signal in the case where a predetermined time passes; and a gate circuit executing a logical sum between a count completion notification signal from the counter circuit and the detection signal and generating the system activation enable signal.

7. The apparatus according to claim 6, wherein
the detection unit is a comparator receiving a voltage of the battery and a predetermined reference voltage, and comprises a comparator generating a detection signal in the case where a voltage of the battery is equal to or lower than a reference voltage.

8. The apparatus according to claim 7, wherein
the AC adapter charging time monitor unit operates by power supply from the AC adapter.

9. The apparatus according to claim 5, wherein
the notification unit comprises: a gate circuit performing a logical sum between a voltage stable signal generated by the stable voltage detection unit and a system activation enable signal generated by the AC adapter charging time monitor unit; and an indicator connected to an output terminal of the gate circuit and lighted, and turned off in the case where the voltage stable signal and the system activation enable signal are input to the gate circuit and a high level signal is output.

10. A apparatus for preventing a malfunction, comprising:
a stable voltage detection unit receiving a voltage of the battery and a predetermined reference voltage, and generating a voltage stable signal in the case where the voltage of the battery is equal to or higher than the predetermined reference voltage;
a detection unit outputting a detection signal in the case of a operation stop status of electronic equipment due to low voltage detection of a battery from a voltage value of the battery;
a charge detection unit outputting a charge detection signal in the case where charge of a battery by an AC adapter is detected;
an AC adapter charging time monitor unit counting up to a predetermined time while the charge detection signal is input, and outputting a system activation enable signal in the case where the detection signal is detected;
a notification unit notifying that a system can be activated in the case of simultaneously detecting a voltage stable signal generated by the stable voltage detection unit and a system activation enable signal generated by the AC adapter charging time monitor unit, and notifying that the system cannot be activated in the case where at least one of the signals is not detected.

11. The apparatus according to claim 10, wherein
the AC adapter charging time monitor unit is a counter circuit starting counting in the case where the charge detection signal is input, and comprises: a counter circuit generating a count completion notification signal in the case where a predetermined time passes; and a gate circuit executing a logical sum between a count completion notification signal from the counter circuit and the detection signal and generating the system activation enable signal.

12. The apparatus according to claim 11, wherein the detection unit is a comparator receiving a voltage of the battery and a predetermined reference voltage, and comprises a comparator generating a detection signal in the case where a voltage of the battery is equal to or lower than a reference voltage.

13. The apparatus according to claim 12, wherein the notification unit comprises: a gate circuit performing a logical sum between a voltage stable signal generated by the stable voltage detection unit and a system activation enable signal generated by the AC adapter charging time monitor unit; and an indicator connected to an output terminal of the gate circuit and lighted, and turned off in the case where the voltage stable signal and the system activation enable signal are input to the gate circuit and a high level signal is output.

14. A method for preventing a malfunction for electronic equipment for use with a power supply control device, comprising:
measuring a charging time of a battery in an operation stop status of electronic equipment due to a low voltage detection on the battery; and
supplying power to a system in the case where a remaining amount of battery of the battery is equal to or more than a predetermined remaining amount of battery, and in the case where a charge measuring time exceeds a predetermined time.

15. The apparatus according to claim 5, wherein the AC adapter charging time monitor unit is a counter circuit starting counting in the case where the charge detection signal is input, and comprises: a counter circuit generating a count completion notification signal in the case where a predetermined time passes; and a gate circuit executing a logical sum between a count completion notification signal from the counter circuit and the detection signal and generating the system activation enable signal.
